(19) United States
(12) Patent Application Publication
(10) Pub. No.: US 2012/0246012 A1
(43) Pub. Date: Sep. 27, 2012

(54) OPEN MOBILE MEDIA MARKETPLACE

(76) Inventors: Nigel Gower, Woodstock, GA (US); Kurt Myers, Roswell, GA (US)

(21) Appl. No.: 13/071,439

(22) Filed: Mar. 24, 2011

(51) Int. Cl. G06Q 30/00

(52) U.S. Cl. 705/14.69; 705/14.73

(57) ABSTRACT

A system and associated methods are disclosed for implementing and sustaining an open opt-in media marketplace for cross-media advertising management using Rich Internet Applications in a cloud. This technology also provides a system and associated methods for providing collaborative data sharing and transfer among approved users and dynamically connecting from mobile and static devices to create, review, modify, and share advertising content, requests, and sales and purchases across multiple media type outlets simultaneously.

### FIELD OF THE INVENTION

The technology described herein relates generally to the fields of media, advertising, data processing, cloud computing, and collaborative data sharing. More specifically, this technology relates to a system and associated methods for implementing an open opt-in media marketplace for cross-media advertising management using Rich Internet Applications in a cloud. Furthermore, this technology relates to a system and associated methods for providing collaborative data sharing and transfer among approved users and dynamically connecting from mobile and static devices.

### BACKGROUND OF THE INVENTION

Traditional media buying, regardless of the media outlet type, has required experienced and knowledgeable media buyers possessing intimate knowledge of the media sector. This typically requires a media buyer maintain established relationships with sellers at the various media outlets in each sector, i.e. television, radio, out-of-home, print, mobile, internet, etc. Media buyers generally specialize in a single media sector. Thus, numerous media analysts typically are required to execute a campaign for an advertiser that crosses multiple media platforms.

The advertising industry continues to experience rapid transition to new and emerging media types (i.e., internet, mobile, venue, product placement, instant messaging, etc.) that put pressure on the traditional media types of print, television, and radio. All types of media are experiencing faster and faster turnaround of campaigns and shortened lengths of campaign runs. This contributes to an increase in the volume of campaigns required to accomplish the rating points or gross impressions desired and expected by advertisers.

A more efficient and effective process requires the ability to interact with the media buyers where and when they require that capability. Mobile applications with seamless connectivity to web-based applications for data access, storage, and processing provide the media buyer with the timely access needed for the most responsive and flexible campaign management process available.

### BRIEF SUMMARY OF THE INVENTION

In various exemplary embodiments, the technology described herein provides systems and associated methods for implementing an open opt-in media marketplace for cross-media advertising management using Rich Internet Applications in a cloud. Furthermore, this technology provides a system and associated methods for providing collaborative data sharing and transfer among approved users and dynamically connecting from mobile and static devices.

The technology described herein enables a media buyer with minimal or no media buying experience to create, execute, and manage full advertising media campaigns across multiple media outlet types without direct and specific knowledge of or relationships with the numerous media outlets they select to become part of the campaign. The technology described herein enables the media buyer to establish and maintain ad hoc, pre-planned and persistent business relationships with complimentary media business partners to complete their media buying, selling, and management requirements via downloadable and integrated Rich Internet Applications for mobile and static devices.

This technology provides innovative and dynamic mobile access to find, create, execute, and manage multi-media sector campaigns enabling both experienced and novice media buyers to have real-time capabilities for operating their advertising business processes.

This technology employs a unique embedded “DNA” or “Data-Network-Application” processing that is the nucleus of the system and is included in all the Rich Internet Apps enabling all components to interoperate seamlessly.

In one exemplary embodiment, the technology described herein provides a method for implementing an open opt-in media marketplace for cross-media advertising management using Rich Internet Applications in a cloud and for providing collaborative data sharing and transfer among approved users and dynamically connecting from mobile and static devices.

The method includes one or more of the following method steps: 1) providing an applications store configured as an opt-in media marketplace accessible by a user; 2) providing a plurality of Rich Internet Applications stored within and available for access from the applications store by the user, wherein a Data-Network-Application (DNA) structure configured to enable each RIA to exchange data with other RIAs, collaborate over a network with other users, and interact with other RIAs as a single business process, is embedded within each Rich Internet Application; 3) downloading, by the user, one of the plurality of Rich Internet Applications; 4) providing a data exchange engine interface storage; 5) maintaining, by a data exchange engine accessing the data exchange engine interface storage, a plurality of data interface mappings for the plurality of Rich Internet Applications; 6) providing a network knowledge engine relationship storage; 7) maintaining, by a network knowledge engine accessing the network knowledge engine relationship storage and configured to control the knowledge of the user's capabilities and the user's interaction with all of the user's social business network partners, the user's partnership relationships; 8) providing an application access engine within each Rich Internet App; 9) prompting the user with inviting other users to connect; 10) prompting the user with other Rich Internet Apps to download; 11) enabling automatic sharing and data transfer between users; 12) providing an online data sharing storage; and 13) storing shared online data in the online data sharing storage.

In another exemplary embodiment, the technology described herein provides a system for implementing an open opt-in media marketplace for cross-media advertising management using Rich Internet Applications in a cloud and for providing collaborative data sharing and transfer among approved users and dynamically connecting from mobile and static devices.

The system includes one or more of the following: 1) an applications store configured as an opt-in media marketplace accessible by a user; 2) a plurality of Rich Internet Applications stored within and available for access and download from the applications store by the user, wherein a Data-Network-Application (DNA) structure configured to enable each RIA to exchange data with other RIAs, collaborate over a network with other users, and interact with other RIAs as a single business process, is embedded within each Rich Internet Application; 3) a data exchange engine interface storage; 4) a data exchange engine configured to maintain the data exchange engine interface storage and a plurality of data interface mappings for the plurality of Rich Internet Applications; 5) a network knowledge engine relationship storage; 6) a network knowledge engine configured to access the network knowledge engine relationship storage and configured to control the knowledge of the user's capabilities, interaction with all of the user's social business network partners, and the user's partnership relationships; 7) an application access engine within each Rich Internet App, configured to prompt the user with inviting other users to connect, prompt the user with other Rich Internet Apps to download, and enable automatic sharing and data transfer between users; and 8) an online data sharing storage configured to store shared online data.

In yet another exemplary embodiment, the technology described herein provides a computer readable storage medium encoded with programming for implementing an open opt-in media marketplace for cross-media advertising management using Rich Internet Applications in a cloud and for providing collaborative data sharing and transfer among approved users and dynamically connecting from mobile and static devices.

The computer readable storage medium encoded with programming is configured to perform one or more of the following process steps: 1) provide an applications store configured as an opt-in media marketplace accessible by a user; 2) provide a plurality of Rich Internet Applications stored within and available for access from the applications store by the user, wherein a Data-Network-Application (DNA) structure configured to enable each RIA to exchange data with other RIAs, collaborate over a network with other users, and interact with other RIAs as a single business process, is embedded within each Rich Internet Application; 3) accept a download, by the user, one of the plurality of Rich Internet Applications; 4) provide a data exchange engine interface storage; 5) maintain, by a data exchange engine accessing the data exchange engine interface storage, a plurality of data interface mappings for the plurality of Rich Internet Applications; 6) provide a network knowledge engine relationship storage; 7) maintain, by a network knowledge engine accessing the network knowledge engine relationship storage and configured to control the knowledge of the user's capabilities and the user's interaction with all of the user's social business network partners, the user's partnership relationships; 8) provide an application access engine within each Rich Internet App; 9) prompt the user with inviting other users to connect; 10) prompt the user with other Rich Internet Apps to download; 11) enable automatic sharing and data transfer between users; 12) provide an online data sharing storage; and 13) store shared online data in the online data sharing storage.

Advantageously, the systems and associated methods described herein provide a media buyer with minimal or no media buying experience to create, execute, and manage full advertising media campaigns across multiple media outlet types without direct and specific knowledge of or relationships with the numerous media outlets they select to become part of the campaign.

Also advantageously, the systems and associated methods described herein enable a media buyer to establish and maintain ad hoc, pre-planned, and persistent business relationships with complimentary media business partners to complete their media buying, selling, and management requirements via downloadable and integrated Rich Internet Applications for mobile and static devices.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a schematic diagram illustrating a system architecture for implementing the Data-Network-Application (DNA) processing of the application, illustrating, in particular, the interaction between the Data Exchange Engine, Network Knowledge Engine, and Application Access Engine within the Rich Internet Applications and data storage points in the dynamic opt-in mobile network, according to an embodiment of the technology described herein;

FIG. 2 is a schematic diagram illustrating an open media advertising marketplace and the Data Exchange Engine (D), Network Knowledge Engine (N), and Application Access Engine (A), according to an embodiment of the technology described herein;

FIG. 3 is a schematic diagram illustrating a close-up view of the Data Exchange Engine (D) depicted in FIG. 2;

FIG. 4 is a schematic diagram illustrating a close-up view of the Network Knowledge Engine (N) depicted in FIG. 2;

FIG. 5 is a schematic diagram illustrating a close-up view of the Application Access Engine (A) depicted in FIG. 2;

FIG. 6 is a schematic diagram illustrating a functional grouping and high-level flow of potential mobile applications to specifically service the advertising industry, according to an embodiment of the technology described herein;

FIG. 7 is a schematic diagram illustrating networks viewable on a mobile device, illustrating, in particular, owners, statistics, and navigation buttons, according to an embodiment of the technology described herein; and

FIG. 8 is a block diagram illustrating the general components of a computer according to an exemplary embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides systems and associated methods for implementing an open opt-in media marketplace for cross-media advertising management using Rich Internet Applications in a cloud. Furthermore, this technology provides a system and associated methods for providing collaborative data sharing and transfer among approved users and dynamically connecting from mobile and static devices.

The technology described herein enables interoperable applications for mobile and static devices to automatically connect and share data.

Each Rich Internet App (RIA) contains embedded DNA (“Data-Network-Application” processing) that is specific and unique to that RIA. The embedded DNA enables the RIA to exchange data with other RIAs, collaborate over the network with other users, and interact with other RIAs as a single business process on the mobile device. Having the DNA embedded within each RIA makes each RIA able to function completely independent when selected for a unique single purpose business function. The Embedded DNA also enables the RIA to seamlessly connect with other RIAs on the device when forming a total business process.

A unique Data Exchange Engine maintains the logical relationships of all the applications in the system and the data standards of how they exchange data. This function is created for each business suite of applications and functions as the standard data relationships for that business vertical. The Data Exchange Engine is updated when new business processes are defined or as new applications are added to the system with previously undefined data sets. The Data Exchange Engine maintains all required data formatting parameters and sets a standard that enable all Business Applications to exchange data on common business processes from directly within their applications as part of the normal transaction flow. For the media industry campaign standards, search standards, buy standards, ad creating standards, Tag standards, ad trafficking standards, and manage my media property standards are defined.

The Data Exchange Engine maintains the standardized data interfaces throughout the system. This includes RIAs that are on the device for that user and RIAs that are on devices of other users with which the user shares data. All Rich Internet Apps have unique and specific data requirements that are part of the business functions they perform. The Data Exchange Engine is embedded into each RIA and contains the data requirements and standards for that RIA to function in the system.

The Data Exchange Engine is designed to accommodate all the data element sets of individual business verticals and retains the knowledge of the data exchange requirements of each Rich Internet App available in each business area. The structures of the Data Exchange Engine are resident on a central web-based repository where the data structures for all RIAs are maintained. When a new RIA is created and made available in the app store servicing any given device, an update is provided automatically to the Data Exchange Engine on each user's device the next time any RIA is accessed.

The Data Exchange Engine enables all RIAs to send and receive data to complete their various business processes. This unique process makes it possible for each RIA to be upgraded and enhanced without requiring the wholesale updating of every other RIA with which it communicates, either resident within the device or with RIAs being used by other network users. The embedded Data Exchange Engine enables each individual RIA to operate standalone for the specific business processes within that RIA and to also automatically interact with other RIAs present on the mobile device.

The Network Knowledge Engine controls the knowledge of the user's capabilities and their interaction with all of their social business network partners. The Network Knowledge Engine knows what other partners are included in the user's “network of partners” and what rights they have in the interaction process with that user. Network partners are invited by a user to participate in the various business functions directly from individual Rich Internet Apps.

With the Network Knowledge Engine, the embedded DNA enables each user to control with whom and how they interact to share, exchange and collaborate on business transactions between users.

The Network Knowledge Engine keeps track of all other users to which the mobile device user has granted collaboration rights. The user has the ability to invite other users into their social business network and grant various rights to those users to work together on groups and individual transactions. A user can transfer, exchange or collaborate with other RIA users who have also installed one or more of the RIAs on their mobile devices. These users can also electronically send via email or file sharing services various files of their information to users outside of the RIA community and the Network Knowledge Engine keeps track of those user parameters as well.

The Network Knowledge Engine maintains how the mobile device user functions as a player in the network processes of other users. Just as the user invites and interacts with other social business partners, they too become the recipients of the same type of requests from other users. The community of an individual user's social business partners is maintained within the mobile device as part of the embedded DNA.

The Application Access Engine provides the core business functionality for each business process. Users select which Rich Internet Apps they want based on the business processes they need to perform. Each Rich Internet App will recommend other complimentary Rich Internet Apps that will interoperate together to form and complete an end-to-end business process, and thus those others apps become self-discovering.

The Application Access Engine enables each RIA to function with specific business processes and capabilities. Each RIA has individual and unique processes and functions that it provides as well as the ability to connect and process data cohesively with other RIA with plug-n-play interoperability. The Application Access Engine identifies for the RIA what other RIAs are complimentary to the various business processes threaded throughout the original application and will dynamically bind those other RIAs into the process if they are already on the user's device, or prompt the user to download and install those RIAs as complementary add on applications.

This dynamic binding and prompted linking enable the individual RIA to grow and emerge into a full set of RIA apps that cohesively function as a single suite of apps without forcing the user to determine ahead of time, what functions or features they are ultimately going to require.

The three components of the DNA are intentionally kept separate and distinct in their function and processing. This enables a great amount of flexibility to provide both private and public RIA suites to both media outlets as well as media buyers.

The Open Mobile Media Marketplace provides the entire core of Rich Internet Apps that are needed to enable any media outlet to present their media to the marketplace in an open fashion. But many media outlets, especially large corporations with multiple outlets, will want to have a private label implementation of the marketplace they can then provide to their specific customers. They will be able to achieve this by having only a single Find Media customized app built specifically for them with their unique branding and processing functions they may require with access only to their data if they so desire.

Their custom Find Media app will automatically plug into the entire Application Access Engine component of the supporting RIA apps to provide them a full suite of functionality. But by having the Network Knowledge engine separate and distinct from the Application Access Engine, they will be able to limit the access to their own private network of users if they choose. At the same time, they automatically share the data between themselves and their users as it is defined and managed by the Data Exchange Engine. By having only a single RIA customized for their unique needs, they still gain the power of the entire marketplace.

The technology described herein utilizes unique standardized search and filter criteria. The data for each media type is structured to enable the user to search across media types and still return responses that can be analyzed in apples-to-apples results. This standardized categorization of media selection criteria accessible from a mobile application is unique and unknown to the industry.

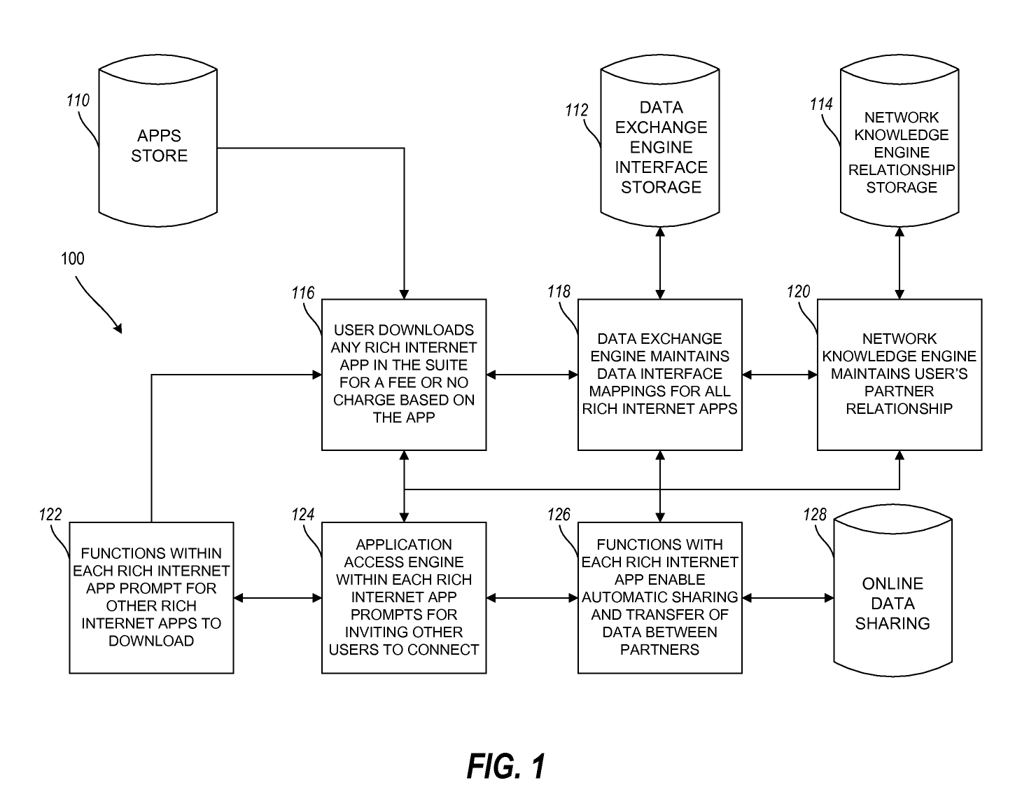

Referring now to FIG. 1, a schematic diagram illustrating system architecture 100 for an open mobile media marketplace and for implementing the Data-Network-Application (DNA) processing of the application is shown. The interactions between the Data Exchange Engine, Network Knowledge Engine, and Application Access Engine within the Rich Internet Applications and data storage points in the dynamic opt-in mobile network are shown.

The system architecture 100 includes an apps store 110. The apps store 110 is configured to store a multiplicity of Rich Internet Applications. By way of example only, and not of limitation, the Rich Internet Applications provide core functions for handling media and connectivity and include: Special Media Content Management; Ad Genie for ad creation, storage, pre-flight, and management; campaign creation, storage and management; Find Media for searching and comparing across multiple media types (broadcast TV, broadcast radio, cable TV, newspapers, magazines, social, local listings, mobile, out-of-home, and internet) with common demographic, geo targeting, budgeting, and event based triggers; Media Properties for enhanced solution networks for specific media types; Tag Media Ads to measure the performance across media platforms; and Last Mile Ads for locations-based offer delivery.

The system architecture 100 includes storage 112 for the Data Exchange Engine interfaces. Data interface mappings for all Rich Internet Applications can be stored within data storage 112.

The system architecture 100 includes storage 114 for the Network Knowledge Engine relationships. User's partner relationships can be stored within data storage 114.

The system architecture 100 includes storage 128 for online data sharing. Data pertaining to online sharing, such as for example, but not of limitation, user connections, potential user connections, suggestions for connections and/or applications, and so forth can be stored in data storage 128.

At step 116, a user downloads any Rich Internet Application in the suite from the apps store 110. The Rich Internet Application can be obtained for a fee or at no charge dependent upon the application. The Rich Internet Application is downloadable by a user.

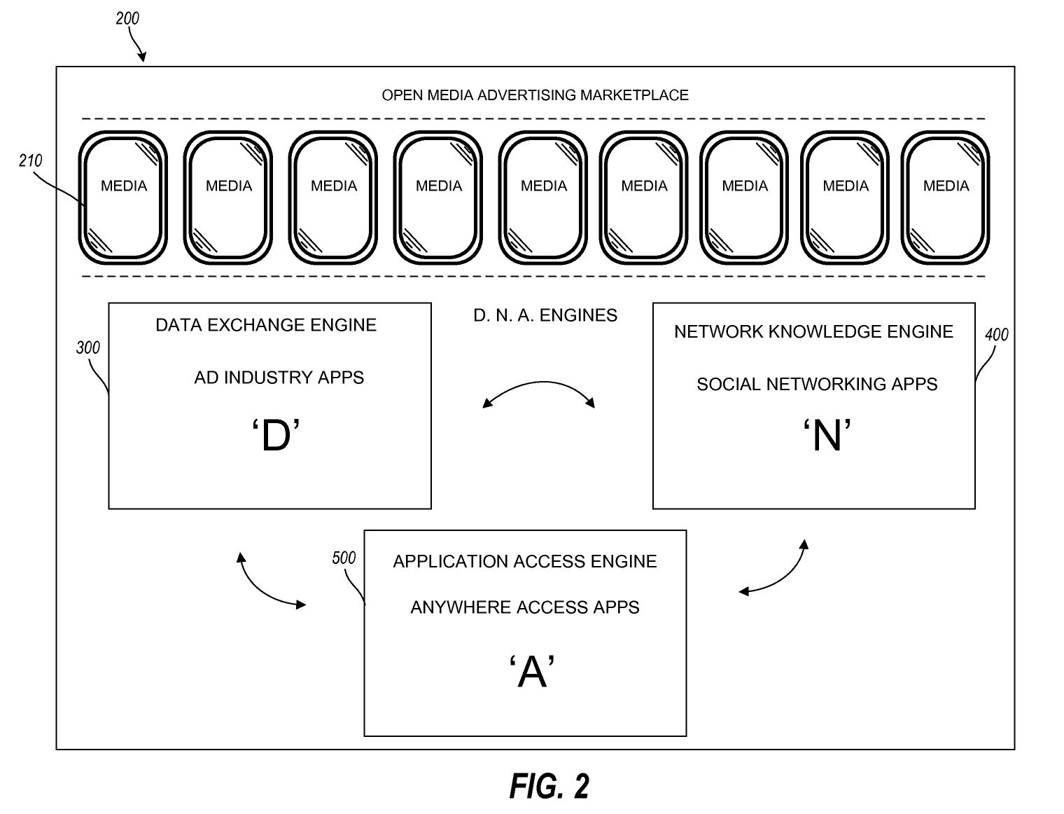

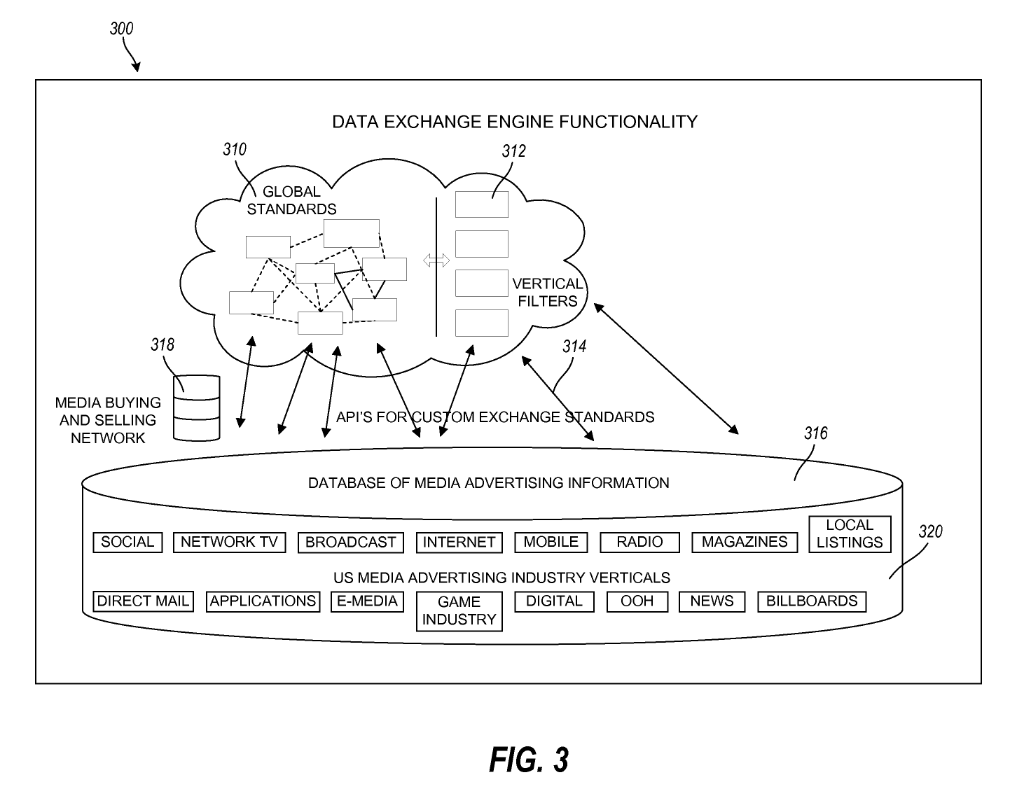

At step 118, the Data Exchange Engine maintains data interface mappings for all Rich Internet Apps. Functionality of the Data Exchange Engine in relation to the Network Knowledge Engine and the Application Access Engine is depicted in FIG. 2. Functionality of the Data Exchange Engine is illustrated in FIG. 3. The Data Exchange Engine maintains global data standards, media type specific filters, and integration of outside custom package media solutions. Automating searching for media is accomplished using defined industry standards for demographic, psychographic, geographic, keyword and budget data structures across all media types.

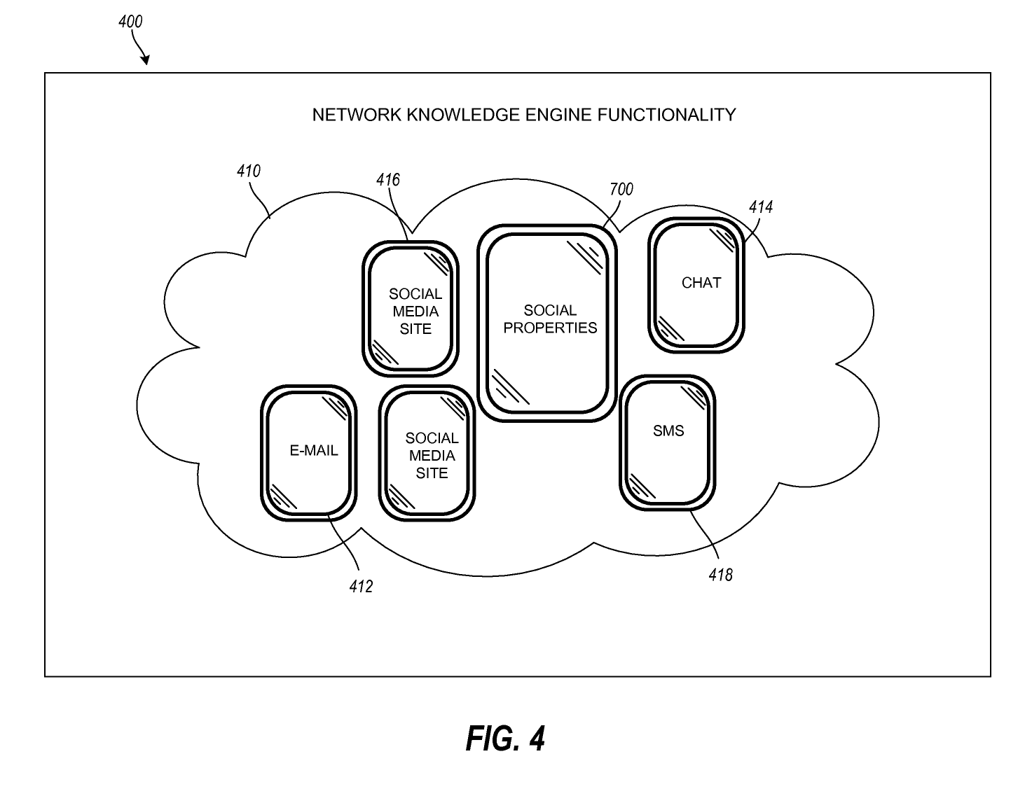

At step 120, the Network Knowledge Engine maintains a user's partner relationships. Functionality of the Network Knowledge Engine in relation to the Data Exchange Engine and the Application Access Engine is depicted in FIG. 2. Additional functionality of the Network Knowledge Engine is illustrated in FIG. 4. The Network Knowledge Engine and associated applications of the DNA permits sharing and collaborating in a customized network cloud. These apps control each user's capabilities and their interaction with their entire network of partners permitting the system to dynamically communicate, manage, share, and transfer data to and from partner users within the network. Users can dynamically create communities with secure and automated data sharing features. These apps provide the messaging and media data sharing which allows you to exchange messages and information with your network and contacts. Users can manage and view their profile across their network, and communicate with users in their network by simply clicking chat, phone, SMS, or email. Shared data and media files are easily transferred through drop boxes across their network using datasets standards such as: properties, offers, campaigns, and ads.

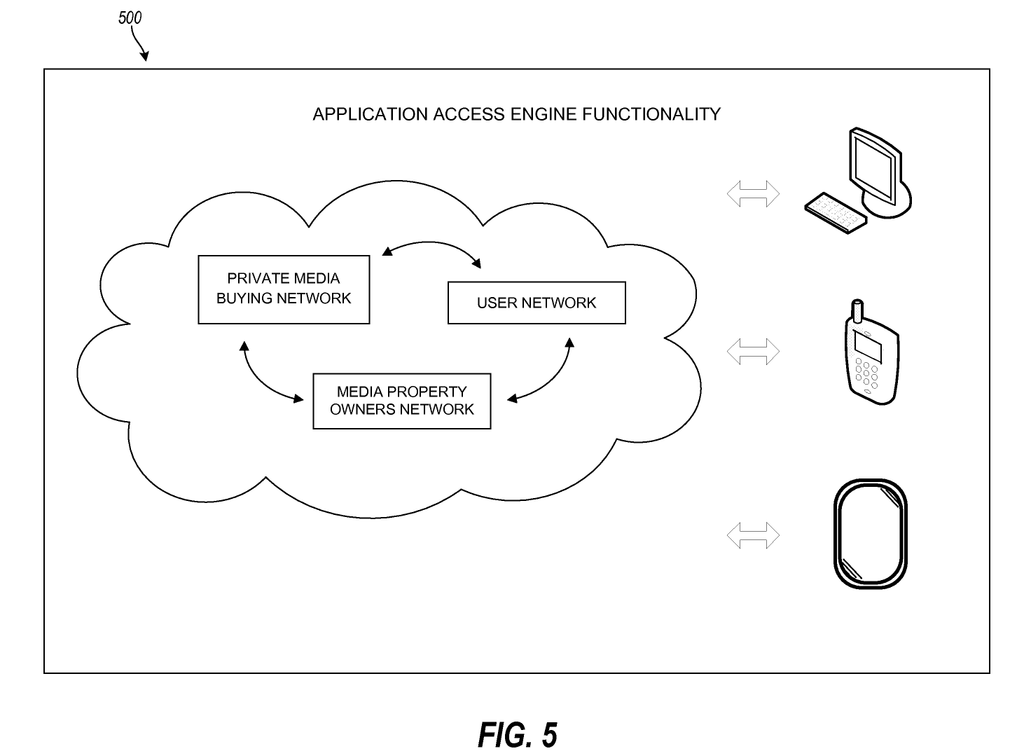

At step 124, the Application Access Engine within each Rich Internet App prompts for inviting others users to connect. Functionality of the Application Access Engine in relation to the Data Exchange Engine and the Network Knowledge Engine is depicted in FIG. 2. Additionally functionality of the Application Access Engine is depicted in FIG. 5. The Application Access Engine and applications of the DNA provide the modular structure for Rich Internet Apps and the plug-n-play interoperability with other add-on Apps.

At step 122, functions within each Rich Internet App prompt for other Rich Internet Apps to download. Apps are self-discovering, in that they dynamically recommend and connect to complimentary applications to complete unique business functions. Apps automatically link together forming an entire business suite.

At step 126, functions within each Rich Internet App enable automatic sharing and transfer of data between partners. Each App can function as a standalone as well as together with other Apps to dynamically and seamlessly exchange and share data.

As will be apparent to one of ordinary skill in the art, upon reading this disclosure, some of the above methods steps may be implemented in varying order depending on the given circumstances. Additionally, one or more method steps may be omitted under the appropriate circumstances.

Referring now to FIG. 2, a schematic diagram 200 illustrating an open media advertising marketplace and the Data Exchange Engine (D), Network Knowledge Engine (N), and Application Access Engine (A) is shown. The open media advertising marketplace contains a multiplicity of media options 210. The Data Exchange Engine 300 (the ‘D’), the Network Knowledge Engine (the ‘N’), and the Application Access Engine (the ‘A’) are collectively the D.N.A. or Data-Network-Application processing that forms the nucleus of the system. The DNA is included in all Rich Internet Applications. The DNA enables interoperable applications for mobile and static devices to automatically connect and share data.

Referring now to FIG. 3, the Data Exchange Engine (D) 300 is depicted. The Data Exchange Engine 300 maintains the logical relationships of all the applications in the system, such as those contained in the database 316 of media advertising information and the data standards of how they exchange data in a media buying and selling network 318. Media advertising industry verticals 320 are contained in the database 316. Media advertising industry verticals 320 include, for example, social, network television, broadcast, internet, mobile, radio, magazines, local listings, direct mail, applications, e-media, game industry, digital, ooh, news, and billboards. This function is created for each business suite of applications and functions as the standard data relationships for that business vertical. The Data Exchange Engine 300 is updated when new business processes are defined or as new applications are added to the system with previously undefined data sets. The Data Exchange Engine 300 maintains all required data formatting parameters and sets a standard that enables all Business Applications to exchange data on common business processes from directly within their applications as part of the normal transaction flow. For the media industry campaign standards, search standards, buy standards, ad creating standards, Tag standards, ad trafficking standards, and manage my media property standards are defined.

The Data Exchange Engine 300 maintains the standardized data interfaces throughout the system. This includes RIAs that are on the device for that user and RIAs that are on devices of other users with which the user shares data. All Rich Internet Apps have unique and specific data requirements that are part of the business functions they perform. The Data Exchange Engine 300 is embedded into each RIA and contains the data requirements and standards for that RIA to function in the system.

The Data Exchange Engine 300 is designed to accommodate all the data element sets of individual business verticals and retains the knowledge of the data exchange requirements of each Rich Internet App available in each business area. The structures of the Data Exchange Engine 300 are resident on a central web-based repository where the data structures for all RIAs are maintained. When a new RIA is created and made available in the app store servicing any given device, an update is provided automatically to the Data Exchange Engine 300 on each user's device the next time any RIA is accessed.

The Data Exchange Engine and associated apps of the DNA maintain global data standards 310, media type specific filters 312, and integration of outside custom package media solutions 314. Automating searching for media is accomplished using defined industry standards for demographic, psychographic, geographic, keyword and budget data structures across all media types.

The Data Exchange Engine 300 enables all RIAs to send and receive data to complete their various business processes. This unique process makes it possible for each RIA to be upgraded and enhanced without requiring the wholesale updating of every other RIA with which it communicates, either resident within the device or with RIAs being used by other network users. The embedded Data Exchange Engine 300 enables each individual RIA to operate standalone for the specific business processes within that RIA and to also automatically interact with other RIAs present on the mobile device.

Referring now to FIG. 4, the Network Knowledge Engine (N) 400 is depicted. The Network Knowledge Engine 400 controls the knowledge of the user's capabilities and their interaction with all of their social business network partners. The Network Knowledge Engine knows what other partners are included in the user's “network of partners” and what rights they have in the interaction process with that user. Network partners are invited by a user to participate in the various business functions directly from individual Rich Internet Apps.

With the Network Knowledge Engine 400, the embedded DNA enables each user to control with whom and how they interact to share, exchange, and collaborate on business transactions between users. By way of example, and not of limitation, users may interact within cloud 410 with a social media site 416, e-mail 412, SMS 418, and chat 414.

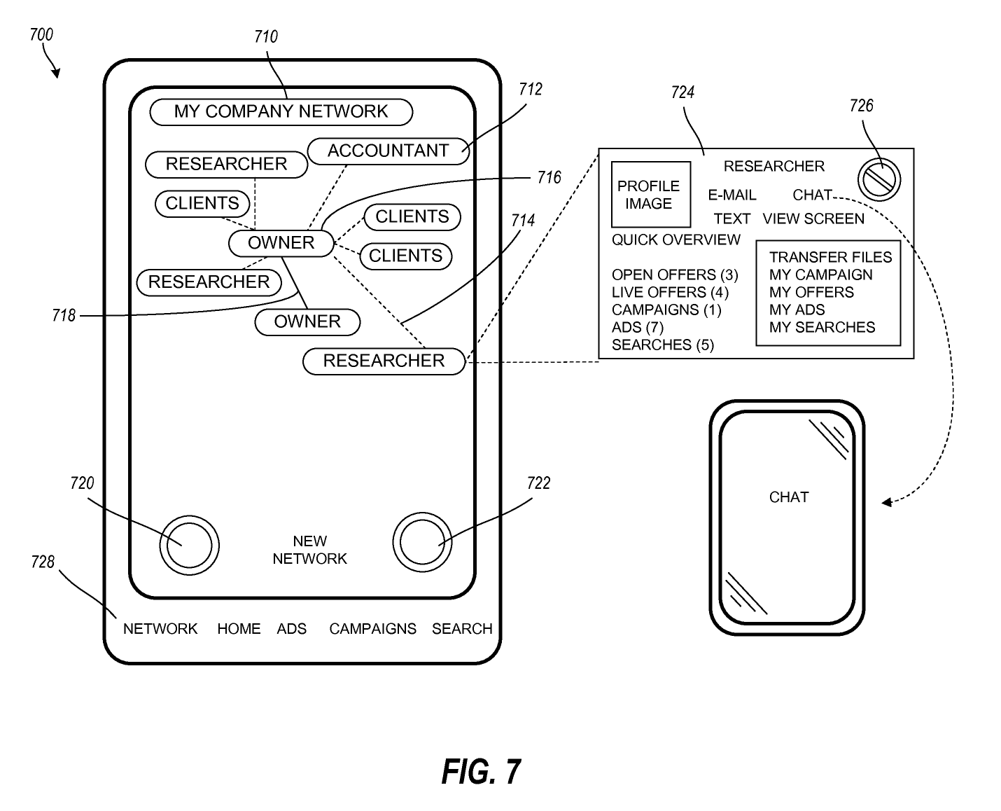

The Network Knowledge Engine 400 keeps track of all other users to which the mobile device user has granted collaboration rights. These rights and other properties can be managed in social properties 700, shown in greater detail in FIG. 7. The user has the ability to invite other users into their social business network and grant various rights to those users to work together on groups and individual transactions. A user can transfer, exchange or collaborate with other RIA users who have also installed one or more of the RIAs on their mobile devices. These users can also electronically send via email 412 or file sharing services various files of their information to users outside of the RIA community and the Network Knowledge Engine 400 keeps track of those user parameters as well.

The Network Knowledge Engine 400 maintains how the mobile device user functions as a player in the network processes of other users. Just as the user invites and interacts with other social business partners, they too become the recipients of the same type of requests from other users. The community of an individual user's social business partners is maintained within the mobile device as part of the embedded DNA.

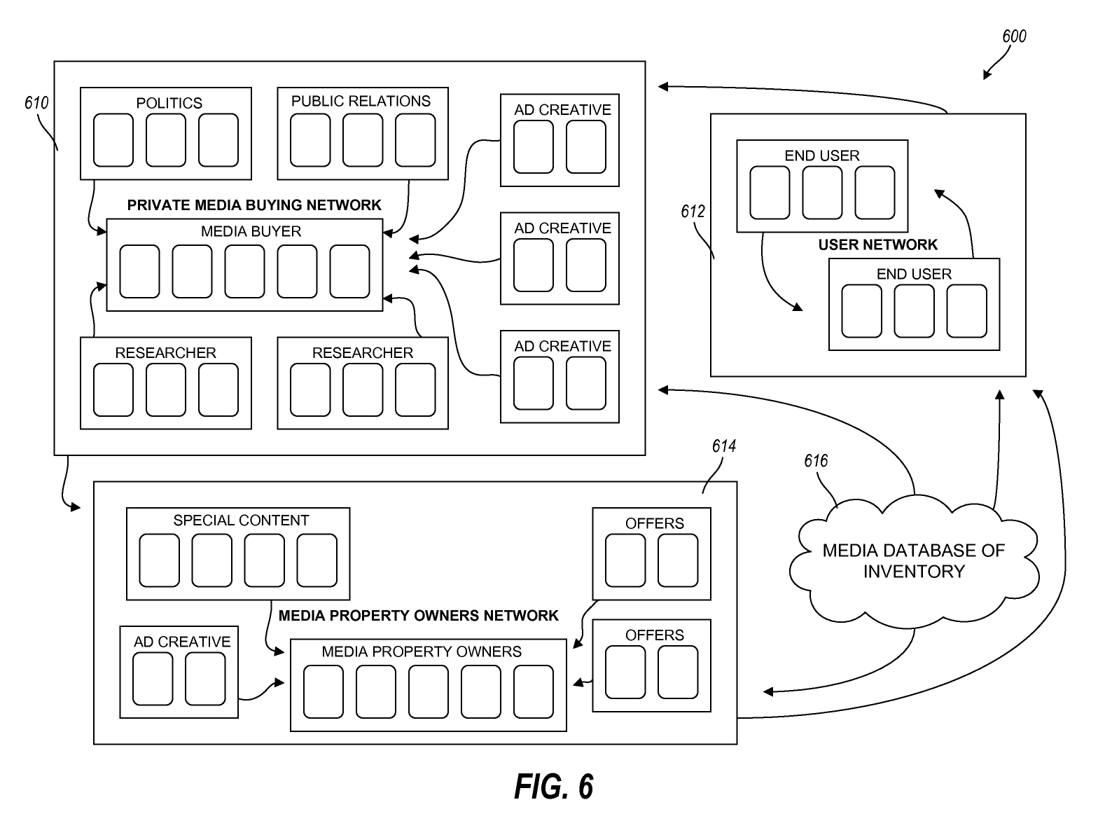

Referring now to FIG. 5, the Application Access Engine (A) 500 is depicted. The Application Access Engine 500 enables each RIA to function with specific business processes and capabilities. Each RIA has individual and unique processes and functions that it provides as well as the ability to connect and process data cohesively with other RIA with plug-n-play interoperability. The Application Access Engine identifies for the RIA what other RIAs are complimentary to the various business processes threaded throughout the original application and will dynamically bind those other RIAs into the process if they are already on the user's device, or prompt the user to download and install those RIAs as complementary add on applications. Communication and collaboration can occur between a private media buying network (see 610 in FIG. 6), a media property owners' network (see 614 in FIG. 6), and a user network (see 612 in FIG. 6).

This dynamic binding and prompted linking of the Application Access Engine 500 enable the individual RIA to grow and emerge into a full set of RIA apps that cohesively function as a single suite of apps without forcing the user to determine ahead of time, what functions or features they are ultimately going to require.

Referring now to FIG. 6, a functional grouping and high-level flow 600 of potential mobile applications to specifically service the advertising industry is shown. Communication and collaboration can occur between a private media buying network 610, a media property owners' network 614, and a user network 612. Each network 610, 612, 614 has access to the media database of inventory 616. The private media buying network 610 can include, for example, media buyers, ad creative, researchers, public relations, politics, and so forth. The media property owners' network 614 can include, for example, offers, social content, ad creative, media property owners, and so forth. The user network 612 can include, for example, a multiplicity of interconnected users collaborating and communicating.

Referring now to FIG. 7, a schematic diagram illustrating networks 700 viewable on a mobile device is shown. The title 710 of the network depicted is “My Company Network.” Information about users on the network, such as Accountant 712, can be viewed. For example, the stats, online chat, send campaigns, ad ads, upload shopping cart, send offer, and so forth, functions can be opened for a user. As depicted in this figure, there are two owners 716 in this network 710. The owners 716 are communicatively coupled with two-way data flow. By comparison, an owner 716 and a researcher are coupled by a one-way data flow 714. A new network 720 can be created. A user can view 722 networks in which he or she is a member. Navigation 728 through other options and applications allows for easy access, for example, to Network, Home, Ads, Campaigns, and Search.

For any user, such as Researcher, a profile 724 is available. The profile 724 can include information such as a profile image and overview. Additionally the profile 724 can include a quick overview of offers, campaigns, ads, and searches. Furthermore, the profile 724 can file transfers and connectivity options such as e-mail, chat, and text, for example. A user can also remove a particular profile from his or her network with the remove option 726.

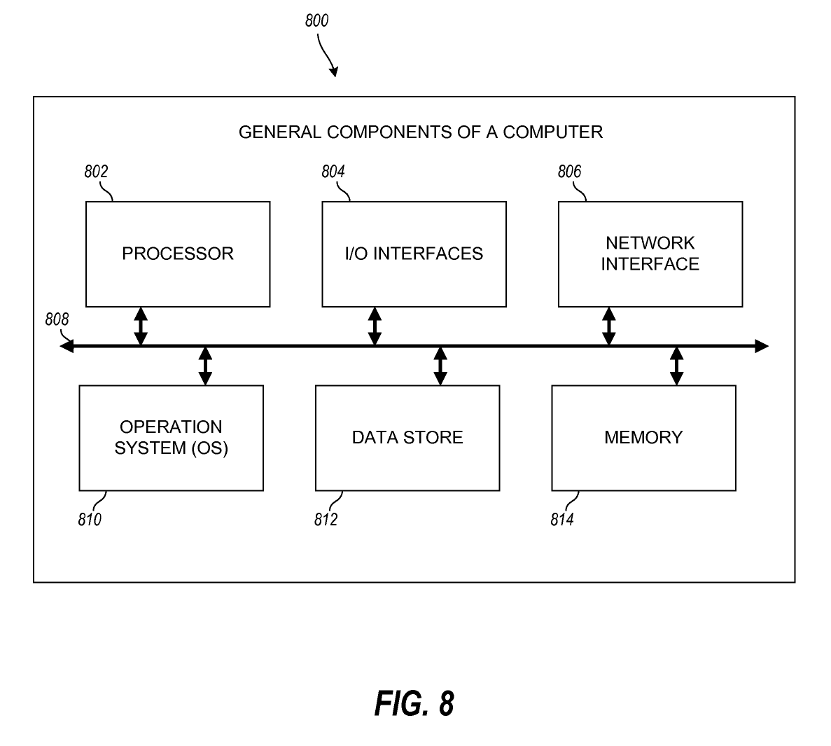

Referring now to FIG. 8, a block diagram 800 illustrating the general components of a computer is shown. Any one or more of the computers, servers, database, and the like, disclosed above, may be implemented with such hardware and software components. The computer 800 can be a digital computer that, in terms of hardware architecture, generally includes a processor 802, input/output (I/O) interfaces 804, network interfaces 806, an operating system (O/S) 410, a data store 812, and a memory 814. The components (802, 804, 806, 810, 812, and 814) are communicatively coupled via a local interface 808. The local interface 808 can be, for example but not limited to, one or more buses or other wired or wireless connections, as is known in the art. The local interface 808 can have additional elements, which are omitted for simplicity, such as controllers, buffers (caches), drivers, among many others, to enable communications. Further, the local interface 808 can include address, control, and/or data connections to enable appropriate communications among the aforementioned components. The general operation of a computer comprising these elements is well known in the art.

The processor 802 is a hardware device for executing software instructions. The processor 802 can be any custom made or commercially available processor, a central processing unit (CPU), an auxiliary processor among several processors associated with the computer 800, a semiconductor-based microprocessor (in the form of a microchip or chip set), or generally any device for executing software instructions. When the computer 800 is in operation, the processor 802 is configured to execute software stored within the memory 814, to communicate data to and from the memory 814, and to generally control operations of the computer 800 pursuant to the software instructions.

The I/O interfaces 804 can be used to receive user input from and/or for providing system output to one or more devices or components. User input can be provided via, for example, a keyboard and/or a mouse. System output can be provided via a display device and a printer (not shown). I/O interfaces 804 can include, for example but not limited to, a serial port, a parallel port, a small computer system interface (SCSI), an infrared (IR) interface, a radio frequency (RF) interface, and/or a universal serial bus (USB) interface.

The network interfaces 806 can be used to enable the computer 800 to communicate on a network. For example, the computer 800 can utilize the network interfaces 808 to communicate via the internet to other computers or servers for software updates, technical support, etc. The network interfaces 808 can include, for example, an Ethernet card (e.g., 10BaseT, Fast Ethernet, Gigabit Ethernet) or a wireless local area network (WLAN) card (e.g., 802.11a/b/g). The network interfaces 808 can include address, control, and/or data connections to enable appropriate communications on the network.

A data store 812 can be used to store data, such as information regarding positions entered in a requisition. The data store 812 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 812 can incorporate electronic, magnetic, optical, and/or other types of storage media. In one example, the data store 812 can be located internal to the computer 800 such as, for example, an internal hard drive connected to the local interface 808 in the computer 800. Additionally in another embodiment, the data store can be located external to the computer 800 such as, for example, an external hard drive connected to the I/O interfaces 804 (e.g., SCSI or USB connection). Finally in a third embodiment, the data store may be connected to the computer 800 through a network, such as, for example, a network attached file server.

The memory 814 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 814 may incorporate electronic, magnetic, optical, and/or other types of storage media. Note that the memory 814 can have a distributed architecture, where various components are situated remotely from one another, but can be accessed by the processor 802.

The software in memory 814 can include one or more software programs, each of which includes an ordered listing of executable instructions for implementing logical functions. The operating system 810 essentially controls the execution of other computer programs, such as the interactive toolkit for sourcing valuation, and provides scheduling, input-output control, file and data management, memory management, and communication control and related services. The operating system 810 can be any of Windows NT, Windows 2000, Windows XP, Windows Vista, Windows 7 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C.), or other like operating system with similar functionality.

In an exemplary embodiment of the technology described herein, one or more computers 800 are configured to perform one or more elements of flowchart 100 depicted in FIG. 1.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A method for implementing an open opt-in media marketplace for cross-media advertising management using Rich Internet Applications in a cloud and for providing collaborative data sharing and transfer among approved users and dynamically connecting from mobile and static devices, the method comprising:
providing an applications store configured as an opt-in media marketplace accessible by a user;
providing a plurality of Rich Internet Applications (RIAs) stored within and available for access from the applications store by the user, wherein a Data-Network-Application (DNA) structure configured to enable each RIA to exchange data with other RIAs, collaborate over a network with other users, and interact with other RIAs as a single business process, is embedded within each Rich Internet Application;
downloading, by the user, one of the plurality of Rich Internet Applications;
providing a data exchange engine interface storage;
maintaining, by a data exchange engine accessing the data exchange engine interface storage, a plurality of data interface mappings for the plurality of Rich Internet Applications;
providing a network knowledge engine relationship storage;
maintaining, by a network knowledge engine accessing the network knowledge engine relationship storage and configured to control the knowledge of the user's capabilities and the user's interaction with all of the user's social business network partners, the user's partnership relationships;
providing an application access engine within each Rich Internet App;
prompting the user with inviting other users to connect;
prompting the user with other Rich Internet Apps to download;
enabling automatic sharing and data transfer between users;
providing an online data sharing storage; and
storing shared online data in the online data sharing storage.

2. The method of claim 1, further comprising:
providing a central web-based repository; and
maintaining a plurality of data structures for all RIAs on the central web-based repository.

3. The method of claim 1, further comprising:
recommending one or more of the plurality of Rich Internet Applications stored within and available for access from the applications store by the user that is best optimized to accommodate and perform on the device from which the user downloads.

4. The method of claim 1, wherein the plurality of Rich Internet Applications comprises advertising applications configured to enable the user to find, manage, buy, and sell media advertising solutions.

5. The method of claim 1, wherein each of the plurality of Rich Internet Applications is adapted to link together with one or more other applications to form a complete media advertising solution.

6. The method of claim 1, further comprising:
maintaining, by the data exchange engine, the logical relationships of all the Rich Internet Applications and the data standards of how they exchange data;
updating the data interface engine when new business processes are defined and as new applications are added with previously undefined data sets;
maintaining, by the data exchange engine, all required data formatting parameters and sets a standard that enable all Rich Internet Applications to exchange data on common business processes from directly within their applications as part of a normal transaction flow;
enabling, by the data exchange engine, all RIAs to send and receive data to complete their various business processes; and
accommodating, by the data exchange engine, all the data element sets of individual business verticals and retains the knowledge of the data exchange requirements of each Rich Internet App available in each business area;
wherein the data exchange engine is embedded into each RIA and contains the data requirements and standards for that RIA to function.

7. The method of claim 1, further comprising:
maintaining, by the network knowledge engine, a network of partners for the user and maintaining what rights the other users have in the interaction process with the user;
enabling, by the network knowledge engine, each user to control with whom and how they interact to share, exchange and collaborate on business transactions between users; and
tracking, by the network knowledge engine, all other users to which the user has granted collaboration rights.

8. The method of claim 1, further comprising:
providing, by the application access engine, the core business functionality for each business process, allowing the user to select which Rich Internet Application is desired based on the business processes needed to perform;
enabling, by the application access engine, each RIA to function with specific business processes and capabilities; and
identifying, by the application access engine, for the RIA what other RIAs are complimentary to the various business processes threaded throughout the original application and dynamically binding those other RIAs into the process if they are already on the user's device, or prompt the user to download and install those RIAs as complementary add on applications.

9. A system for implementing an open opt-in media marketplace for cross-media advertising management using Rich Internet Applications in a cloud and for providing collaborative data sharing and transfer among approved users and dynamically connecting from mobile and static devices, the system comprising:
an applications store configured as an opt-in media marketplace accessible by a user;
a plurality of Rich Internet Applications (RIAs) stored within and available for access and download from the applications store by the user, wherein a Data-Network-Application (DNA) structure configured to enable each RIA to exchange data with other RIAs, collaborate over a network with other users, and interact with other RIAs as a single business process, is embedded within each Rich Internet Application;
a data exchange engine interface storage;
a data exchange engine configured to maintain the data exchange engine interface storage and a plurality of data interface mappings for the plurality of Rich Internet Applications;
a network knowledge engine relationship storage;
a network knowledge engine configured to access the network knowledge engine relationship storage and configured to control the knowledge of the user's capabilities, interaction with all of the user's social business network partners, and the user's partnership relationships;
an application access engine within each Rich Internet App, configured to prompt the user with inviting other users to connect, prompt the user with other Rich Internet Apps to download, and enable automatic sharing and data transfer between users; and
an online data sharing storage configured to store shared online data.

10. The system of claim 9, further comprising:
a central web-based repository configured to maintain a plurality of data structures for all RIAs.

11. The system of claim 9, wherein the plurality of Rich Internet Applications comprises advertising applications configured to enable the user to find, manage, buy, and sell media advertising solutions; and wherein each of the plurality of Rich Internet Applications is adapted to link together with one or more other applications to form a complete media advertising solution.

12. The system of claim 9, wherein the data exchange engine is further configured to: maintain the logical relationships of all the Rich Internet Applications and the data standards of how they exchange data; update when new business processes are defined and as new applications are added with previously undefined data sets; maintain all required data formatting parameters and sets a standard that enable all Rich Internet Applications to exchange data on common business processes from directly within their applications as part of a normal transaction flow; enable all RIAs to send and receive data to complete their various business processes; and accommodate all the data element sets of individual business verticals and retains the knowledge of the data exchange requirements of each Rich Internet App available in each business area; and wherein the data exchange engine is embedded into each RIA and contains the data requirements and standards for that RIA to function.

13. The system of claim 9, wherein the network knowledge engine is further configured to: maintain a network of partners for the user and maintaining what rights the other users have in the interaction process with the user; enable each user to control with whom and how they interact to share, exchange and collaborate on business transactions between users; and track all other users to which the user has granted collaboration rights.

14. The system of claim 9, wherein the application access engine is further configured to: provide the core business functionality for each business process, allowing the user to select which Rich Internet Application is desired based on the business processes needed to perform; enable each RIA to function with specific business processes and capabilities; and identify for the RIA what other RIAs are complimentary to the various business processes threaded throughout the original application and dynamically binding those other RIAs into the process if they are already on the user's device, or prompt the user to download and install those RIAs as complementary add on applications.

15. A computer readable storage medium encoded with programming for implementing an open opt-in media marketplace for cross-media advertising management using Rich Internet Applications in a cloud and for providing collaborative data sharing and transfer among approved users and dynamically connecting from mobile and static devices, the computer readable storage medium encoded with programming configured to:
provide an applications store configured as an opt-in media marketplace accessible by a user;
provide a plurality of Rich Internet Applications (RIAs) stored within and available for access from the applications store by the user, wherein a Data-Network-Application (DNA) structure configured enable each RIA to exchange data with other RIAs, collaborate over a network with other users, and interact with other RIAs as a single business process, is embedded within each Rich Internet Application;
accept a download, by the user, one of the plurality of Rich Internet Applications;
provide a data exchange engine interface storage;
maintain, by a data exchange engine to access the data exchange engine interface storage, a plurality of data interface mappings for the plurality of Rich Internet Applications;
provide a network knowledge engine relationship storage;
maintain, by a network knowledge engine to access the network knowledge engine relationship storage and configured to control the knowledge of the user's capabilities and the user's interaction with all of the user's social business network partners, the user's partnership relationships;
provide an application access engine within each Rich Internet App;
prompt the user with inviting other users to connect;
prompt the user with other Rich Internet Apps to download;
enable automatic sharing and data transfer between users;
provide an online data sharing storage; and
store shared online data in the online data sharing storage.

16. The computer readable storage medium of claim 15, wherein the data exchange engine is further configured to: maintain the logical relationships of all the Rich Internet Applications and the data standards of how they exchange data; update when new business processes are defined and as new applications are added with previously undefined data sets; maintain all required data formatting parameters and sets a standard that enable all Rich Internet Applications to exchange data on common business processes from directly within their applications as part of a normal transaction flow; enable all RIAs to send and receive data to complete their various business processes; and accommodate all the data element sets of individual business verticals and retains the knowledge of the data exchange requirements of each Rich Internet App available in each business area; and wherein the data exchange engine is embedded into each RIA and contains the data requirements and standards for that RIA to function.

17. The computer readable storage medium of claim 15, wherein the network knowledge engine is further configured to: maintain a network of partners for the user and maintaining what rights the other users have in the interaction process with the user; enable each user to control with whom and how they interact to share, exchange and collaborate on business transactions between users; and track all other users to which the user has granted collaboration rights.

18. The computer readable storage medium of claim 15, wherein the application access engine is further configured to: provide the core business functionality for each business process, allowing the user to select which Rich Internet Application is desired based on the business processes needed to perform; enable each RIA to function with specific business processes and capabilities; and identify for the RIA what other RIAs are complimentary to the various business processes threaded throughout the original application and dynamically binding those other RIAs into the process if they are already on the user's device, or prompt the user to download and install those RIAs as complementary add on applications.

19. The computer readable storage medium of claim 15, wherein the programming is further configured to:
provide a central web-based repository; and
maintain a plurality of data structures for all RIAs on the central web-based repository.

20. The computer readable storage medium of claim 15, wherein the plurality of Rich Internet Applications comprises advertising applications configured to enable the user to find, manage, buy, and sell media advertising solutions; and wherein each of the plurality of Rich Internet Applications is adapted to link together with one or more other applications to form a complete media advertising solution.
